(19) United States
(12) Patent Application Publication
(10) Pub. No.: US 2018/0305019 A1
(43) Pub. Date: Oct. 25, 2018

(54) FIXED-WING AIRCRAFT WITH INCREASED STATIC STABILITY

(71) Applicant: Danielson Aircraft Systems, Magny Cours (FR)

(72) Inventor: Frédéric HUBSCHWERLEN, Saint-Pierre-le-Moutier (FR)

(21) Appl. No.: 15/767,650

(22) PCT Filed: Oct. 21, 2016
(86) PCT No.: PCT/FR2016/052720

§ 371 Date: Apr. 12, 2018

(30) Foreign Application Priority Data
Oct. 22, 2015 (FR) 1560067

(51) Int. Cl. B64C 39/06; B64C 21/02; B64C 23/06

(52) U.S. Cl. CPC B64C 39/068; B64C 21/02; B64C 2230/08; B64C 2230/20; B64C 2201/021; B64C 23/076

(57) ABSTRACT

The invention relates to an aircraft having at least one wing (5) including, at each end thereof, a fin (6) forming an angle of between 0° and 45° relative to the vertical. According to the invention, each fin (6) has a leading edge (7) that includes at least one slot (8) provided along said leading edge (7) and oriented so as to cause an air flow to flow via said leading edge (7) from an outer surface (6a) of the fin (6) to an inner surface (6b).

### TECHNICAL FIELD

The present invention concerns the technical field of fixed-wing aircraft, such as an airplane or a drone, and more particularly concerns a fixed-wing aircraft with increased static stability.

Drone is understood as being a pilotless aircraft, commonly called drone or UAV for “Unmanned Aerial Vehicle” or UAS for “Unmanned Aerial System.”

Longitudinal static stability is understood as the ability of the aircraft to counter a disruptive pitching movement. In other words, if the aircraft pitches up or down under the effect of a disruptive action, an opposing, inverse torque should be exerted on said aircraft in order to compensate for the angular displacement caused by the disruptive action, pushing the aircraft to resume an equilibrium position of close to the initial position. Longitudinal static stability is highly desirable to make the aircraft pilotable.

### PRIOR ART

According to the state of the art, a fixed-wing aircraft is known comprising at least one horizontal wing. In general, an aircraft comprises two horizontal wings extending laterally on either side of a central fuselage. The horizontal wing or wings can constitute lifting surfaces which, alone, are unstable in pitch.

In a particular embodiment, the aircraft comprises a horizontal stabilizer, consisting of an assembly of fixed and movable planes situated at the rear of the aircraft, making it possible to stabilize the aircraft.

Also known from the state of the art is creating an artificial static stability by the addition of sensors and an electronic system. However, this system is complex and expensive to implement so that it is rarely used.

The lift of the aircraft is the force perpendicular to the forward direction of the aircraft that is exerted thereupon to maintain it in flight.

The drag of the aircraft is the force parallel to the forward direction, in the opposite direction. By convention, it is divided into two parallel components in the same direction: induced drag and parasitic drag.

Induced drag is the force parallel to the forward direction, in the opposite direction, generated as a result of the lift.

Parasitic drag is the force parallel to the forward direction, in the opposite direction, caused by the friction of the air on the aircraft, local variations in pressure, turbulent separations and various vortices, etc.

Beyond a certain incidence of the angle of attack of the wing or wings, the aircraft suffers a loss of lift. This is called stalling of the aircraft. In general, stalling is generated when the angle of attack of the horizontal wing or wings is between 15° and 18°. This phenomenon greatly limits the lift that can be generated for a given speed (a dynamic pressure) and surface area.

In order to limit this stalling phenomenon, it is known, for example, to increase the lift generated by the horizontal wing or wings, particularly by a technique of blowing the wing or wings with propellers or jets.

However, it has been found that when these solutions are used to increase the lift significantly, they can cause a variation in the angle induced by the horizontal wing or wings with the incidence no longer allowing the horizontal stabilizer to perform its stabilizing function.

Another problem involves the aircraft's induced and parasitic drags, which cause a waste of power.

To compensate for this problem, it is known to extend each free end of the horizontal wing or wings with a winglet forming an angle of between 0° and 45° relative to the vertical. These winglets, fins extending upwards, are well known in the state of the art. These winglets reduce the drag induced by the lift, without increasing the span of the aircraft.

Moreover, in the field of fixed-wing tactical aircraft, these aircraft have the advantage of being less expensive but with the disadvantage of requiring a relatively long takeoff and landing strip. To compensate for this disadvantage, devices have been considered for launching these aircraft, such as takeoff ramps for example. For example, such aircraft are described in the international patent application WO 2011/002331.

The document WO 2011/002331 describes a pilotless aircraft of small dimensions, intended for aerial observation and reconnaissance, which comprises a control station on the ground, means of radiocommunication, navigation and flight control on board and on the ground, a launching device, and a demountable pilotless aircraft carrying a payload. The aircraft has a modular structure and can be easily assembled for flight and disassembled for transport in a compact container. Greater simplicity and structural reliability of the pilotless aircraft, while also decreasing its weight, can be achieved as a result of the innovative structure of the central spar of the fuselage and to the locking connections with stop elements with which to attach wing parts to the fuselage. The unmanned aircraft has the aerodynamic configuration of a flying wing with a propulsive propeller, an electric power unit and a parachute system for landing.

However, this type of aircraft has the disadvantage of poor flight autonomy and does not allow a significant payload on board.

### DESCRIPTION OF THE INVENTION

One of the purposes of the invention, therefore, is to remedy these disadvantages by proposing a fixed-wing aircraft that has increased static stability under conditions of strong lift, while reducing induced and parasitic drags in order to limit the wastage of power of said aircraft and to increase its flight autonomy.

Another objective of the invention is to furnish a pilotless aircraft that is inexpensive and simple in design, small in size and with the possibility of carrying a significant payload while needing a takeoff and landing strip of small dimensions.

To that end, and according to the invention, an aircraft is proposed having at least one wing, preferably horizontal, comprising at each of the ends thereof a winglet forming an angle of between 0° and 45° relative to the vertical, and preferably between 1° and 15° relative to the vertical.

According to the invention, each winglet has a leading edge that comprises at least one slot placed along each leading edge and oriented to make an airflow circulate through said leading edge from an outer surface of the winglet to an inner surface of said winglet. Inner surface of the winglet is understood as the surface of a winglet facing the other winglet.

In this manner, longitudinal slots placed along leading edges of the winglets make it possible to generate a lift on said winglets, the development of which is stabilizing when the angle of attack of the horizontal wing is increased. In other words, the airflow that circulates in the slots generates a lift that has a vertical component, and the variation thereof with the incidence is stabilizing. Indeed, the vertical component of the lift generated by the slots increases with the attack of the horizontal wing. Unlike the horizontal stabilizer, the winglets are not disturbed by the variation of the angle induced by the horizontal wing.

According to the state of the art, it is already known to place longitudinal slots on the leading edge of the horizontal wing, particularly to defer the stalling of the horizontal wing to a higher angle of attack. However, in the configuration according to the invention, there is no reason for deferring the stalling of the winglets. Indeed, in the present invention the slots are not used to defer stalling by generating a perpendicular force on the planes of the winglets, but instead are used to generate a lift with a vertical component, which is contrary to the usual practice. In other words, the slots placed along the leading edges of the winglets produce a particular and unexpected technical effect, unlike the technical effect they produce when they are placed along the leading edge of the horizontal wing.

Preferably, and to increase the lift with vertical component on the winglets and the static stability, the leading edge of each winglet comprises at least two parallel slots.

According to one particular embodiment, each winglet comprises at least one fixed slat situated in front of the leading edge, forming at least one fixed surface separated from the leading edge so as to place said at least one slot between said fixed surface and the leading edge. This embodiment allows a design that is simple, light and inexpensive to implement.

Advantageously, the slat is installed retractably in order to block the slot and avoid creating additional parasitic drag that wastes the power of the aircraft.

According to another embodiment, each winglet comprises at least one flap installed movably to block the slot or slots and avoid creating additional parasitic drag.

Advantageously and to provide additional stabilization, the aircraft comprises a fuselage and a vertical stabilizer

In this latter embodiment, and according to a particular embodiment, each winglet is connected to the vertical stabilizer of the fuselage by means of a wing portion.

Advantageously, and in order to increase the lift with a vertical component on the winglets when the angle of attack of the horizontal wing increases, each winglet is inclined towards the rear of said aircraft, preferably at an angle of between 45° and 65° relative to the vertical, and preferably at an angle of 55° relative to the vertical.

### BRIEF DESCRIPTION OF THE FIGURES

Other characteristics and advantages of the invention will be seen clearly from the following description, provided by way of example and in no way limiting, with reference to the appended figures in which:

FIG. 1 is a perspective view of the aircraft according to the invention,

FIG. 2 is a detailed view of the vertical winglet of the aircraft according to the invention, viewed from the inner side, said winglet comprising two slots along its leading edge,

FIG. 3 is a view similar to the one in FIG. 2, the winglet being viewed from the outer side,

FIG. 4 is a view similar to the one in FIG. 2, the winglet being viewed from above and in transverse section,

FIG. 5 is a view similar to the one in FIG. 4, illustrating another embodiment of the invention, the winglet comprising a retractable slat with single slot,

FIG. 6 is a detailed view of the winglet according to the embodiment of FIG. 5, viewed from the inner side with the retractable slat in the open position,

FIG. 7 is a view similar to the one in FIG. 6 with the retractable slat in the closed position.

### DETAILED DESCRIPTION OF THE INVENTION

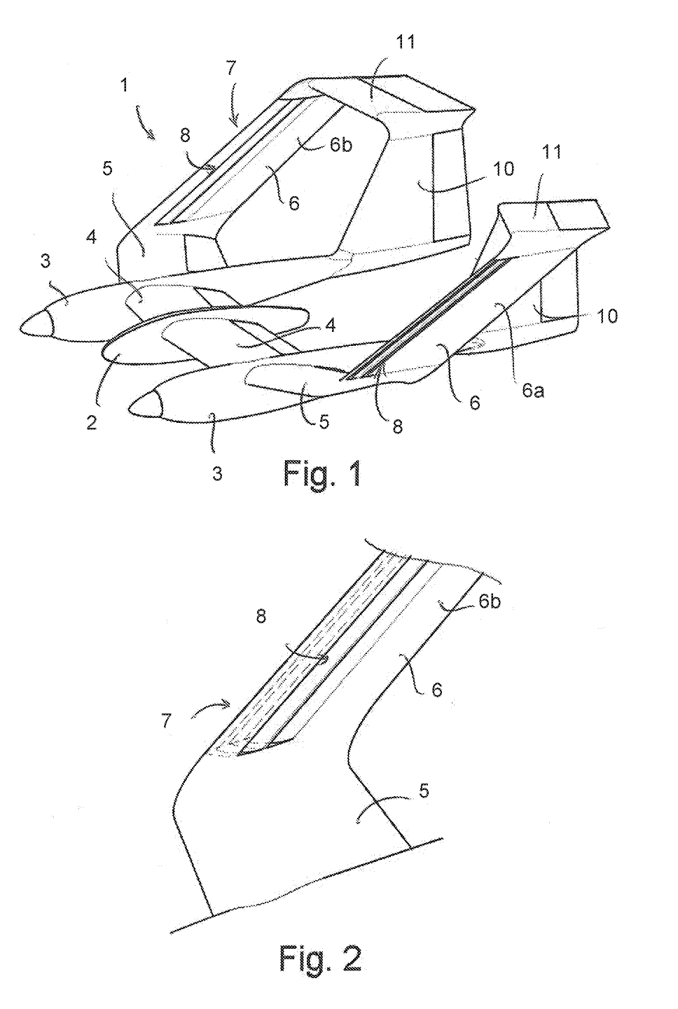

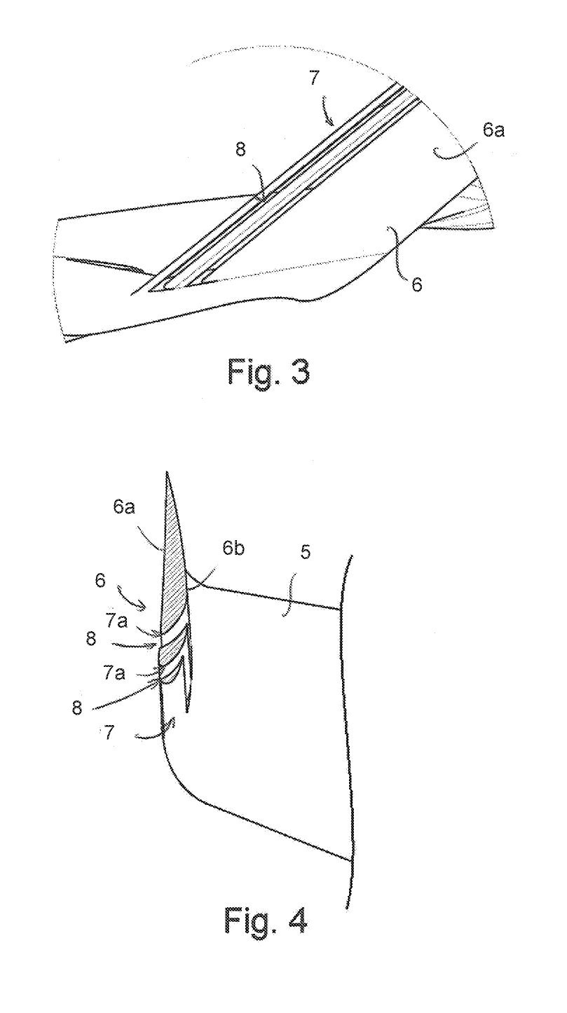

With reference to FIG. 1, the invention is described in relation to a pilotless aircraft (1), commonly called drone, consisting of a central fuselage (2) and two lateral fuselages (3) extending parallel to the central fuselage (2), and carrying respectively, preferably, a means of propulsion (not shown). Said lateral fuselages (3) are connected to the central fuselage (2) by a wing (4) inclined from front to rear. The central fuselage (2) has a length that is less than the length of the lateral fuselages (3).

Moreover, according to the embodiment illustrated in FIG. 1, the aircraft (1) also comprises two substantially horizontal wings (5) extending laterally from said lateral fuselages (3). It will be noted that the aircraft (1) may not include a central fuselage (2) without, however, going beyond the scope of the invention.

Each means of propulsion consists of a motor, not shown in the figures, driving a propeller (not shown) positioned at the front of each lateral fuselage (3). Furthermore, the axis of each propeller forms for example an angle, in the vertical plane, with the plane of the horizontal wings (4) and/or said horizontal wings (4) comprising flaps with single or double or triple slot in order to obtain a so-called blown wing. Thus, the propellers blow directly onto nearly all of the wings and greatly increase the lift in this area.

In this way, the illustrated aircraft (1) has a very high lift coefficient enabling takeoff over a very short distance, for example on the order of 90 m.

Moreover, each horizontal lateral wing (5) comprises, at the free end thereof, a winglet (6) extending upwards and defining in particular an angle of between 0° and 45°, and preferably between 1° and 15° relative to the vertical. Each winglet (6) is, for example, inclined towards the rear of the aircraft (1) at an angle of between 45° and 65° and preferably 55° relative to the vertical.

According to the invention, each winglet (6) has a leading edge (7) that comprises at least one slot (8) placed along each leading edge (7) and oriented to make an airflow circulate through said leading edge (7) from an outer surface (6a) of the winglet (6) to an inner surface (6b). According to the illustrated embodiment, each winglet (6) comprises two slots (8) called parallel longitudinal.

In this way, the passage of an airflow through said slots (8) makes it possible to generate a lift on the winglets (6) that has a vertical component that increases with the incidence of the horizontal wings (4, 5). Said additional lift makes it possible to stabilize the aircraft (1) and to increase the angle at which the horizontal wings (4, 5) stall. Furthermore, the transverse section of the slots (8) is advantageously concave, in such a way that said slots (8) define an additional leading edge (7a) that is curved, and they form a wing profile to generate the lift during the flow of air.

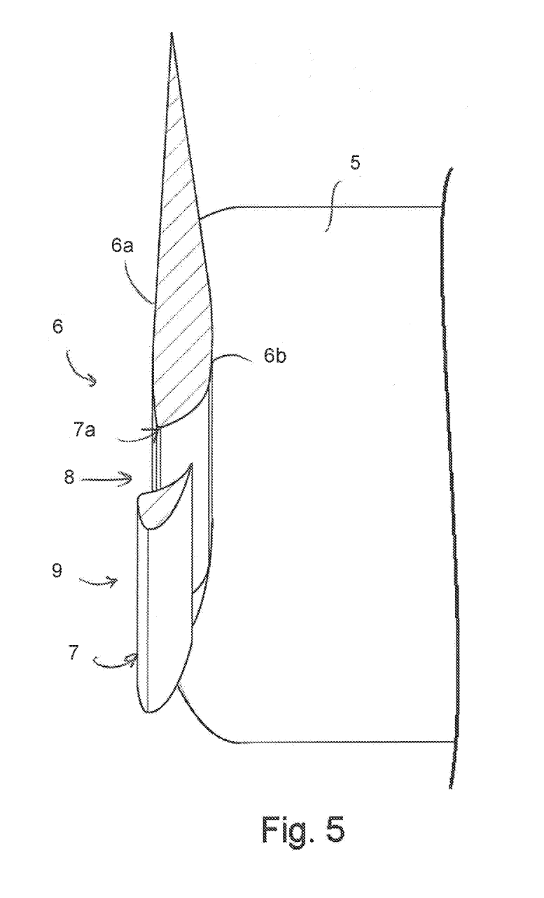

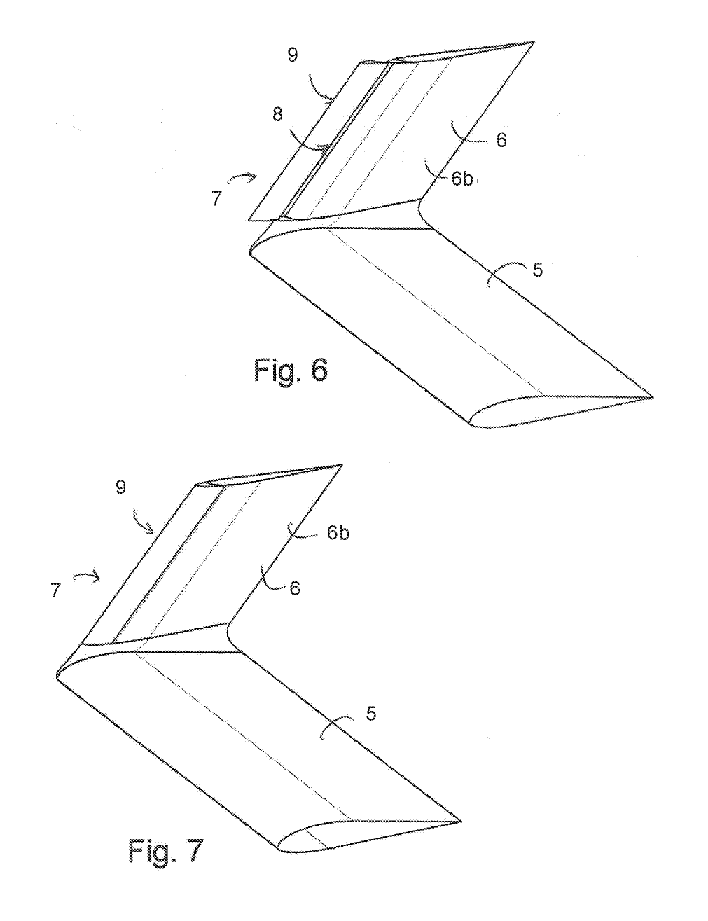

According to a particular embodiment illustrated in FIGS. 5 to 7, each winglet (6) comprises a fixed slat (9) situated in front of the leading edge (7). The fixed slat (9) forms at least one fixed surface separated from the leading edge (7) of the winglet (6) so as to place a slot (8) between said fixed surface and the leading edge (7). The slat (9) is installed retractably to change from a position blocking to a position clearing the slot (8), and to avoid creating an additional parasitic drag that wastes the power of the aircraft (1). It is also possible to achieve this function by means of a flap mounted pivotably on each winglet (6) between a position blocking and a position clearing the slots (8).

According to the embodiment illustrated in FIG. 1, the two lateral fuselages (3) each comprise a vertical stabilizer (10) and each winglet (6) is connected to the vertical stabilizer (10) of the respective lateral fuselage (3) by means of a wing portion (11), preferably extending substantially parallel to the horizontal wings (4). Said wing portion (11) extends from front to rear, forming an angle with the frontal plane of the aircraft (1). In this particular embodiment, the ratio of the height of the winglets (6) to the span of the aircraft (1) is between 0.15 and 0.25, and preferably equal to 0.2. Span is understood as the distance separating the ends of the two horizontal lateral wings (5).

It is quite obvious that this embodiment is a preferred embodiment of the invention. The essence of the invention is the presence of slots (8) placed in the winglets (6) extending upwards and arranged at the ends of the lateral wings (5) of the aircraft (1). For example, simple winglets (a term known to a person skilled in the art) with slots (8) fall within the scope of the present invention.

Moreover, it is obvious that the motors driving the propellers are of any appropriate type, such as preferably heat engines supplied by fuel stored in tanks placed in the lateral fuselages (3) and the horizontal wings (4, 5), or electric motors, without going beyond the scope of the invention.

Lastly, it is clear that the examples that have just been given are only specific illustrations and are by no means limiting as concerns the scope of application of the invention.

1. An aircraft (1) having at least one wing (5) comprising, at each of the ends thereof, a winglet (6) forming an angle of between 0° and 45° relative to the vertical, characterized in that each winglet (6) has a leading edge (7) that comprises at least one slot (8) placed along said leading edge (7) and oriented so as to make an airflow circulate through said leading edge (7) from an outer surface (6a) of the winglet (6) to an inner surface (6b) of said winglet (6).

2. The aircraft (1) according to claim 1, characterized in that the leading edge (7) of each winglet (6) comprises at least two parallel slots (8).

3. The aircraft (1) according to claim 1, characterized in that each winglet (6) comprises at least one fixed slat (9) situated in front of the leading edge (7), forming at least one fixed surface separated from the leading edge (7) so as to place said at least one slot (8) between said fixed surface and the leading edge (7).

4. The aircraft (1) according to claim 3, characterized in that the slat (9) is installed retractably in order to block the slot (8).

5. The aircraft (1) according to claim 1, characterized in that each winglet (6) comprises at least one flap mounted movably in order to block the slot or slots (8).

6. The aircraft (1) according to claim 1, characterized in that it comprises at least one fuselage (3) and one vertical stabilizer (10).

7. The aircraft (1) according to claim 6, characterized in that each winglet (6) is connected to the vertical stabilizer (10) of the fuselage (3) by means of a wing portion (11).

8. The aircraft (1) according to claim 1, characterized in that each winglet (6) is inclined towards the rear of said aircraft (1).

9. The aircraft (1) according to claim 8, characterized in that each winglet (6) is inclined towards the rear of the aircraft (1) at an angle of between 45° and 65° relative to the vertical.
